(19) United States
(12) Patent Application Publication
(10) Pub. No.: US 2019/0257091 A1
(43) Pub. Date: Aug. 22, 2019

(54) Device for Supporting and Concealing Overhead Door Tracks

(71) Applicant: Bryan Alan Hunter, Winter Haven, FL (US)

(72) Inventor: Bryan Alan Hunter, Winter Haven, FL (US)

(21) Appl. No.: 16/278,057

(22) Filed: Feb. 16, 2019

Related U.S. Application Data
(60) Provisional application No. 62/632,027, filed on Feb. 19, 2018.

(51) Int. Cl. E04F 13/074; E05D 15/16; E04F 13/073; E05D 15/24

(52) U.S. Cl. CPC E04F 13/074; E05D 15/165; E06B 3/485; E05D 15/246; E05Y 2900/106; E04F 13/073

(57) ABSTRACT

An article of manufacture which provides structural support for overhead door track systems while concealing the tracks from view, consisting of vertical and horizontal members, which attach to and support the tracks, and which are manufactured with recessed channels or trim elements for visual concealment of the tracks.

### FIELD OF THE DISCLOSURE

The present disclosure relates to overhead door tracks and more specifically to an article of manufacture that provides structural support and conceals from view the vertical and horizontal track systems commonly used in the operation of overhead doors.

### BACKGROUND

Segmental overhead doors, which are commonly used as garage doors as well as in other building applications, typically operate using stand-alone steel tracks to support and guide rollers which are attached to the doors. While these common steel tracks and their corresponding support systems have proven sufficiently functional, by themselves they offer limited structural stability are considered unsightly by many. For owners who desire more structural integrity for their overhead door tracks and/or desire to enhance the aesthetics of these systems, a solution is provided with the device disclosed herein.

### SUMMARY

By providing a device which can attach to and conceal overhead door tracks within manufactured members which are customizable and offer aesthetic and structural options, overhead door track systems can be improved.

The disclosed exemplary embodiments provide such a device. In one embodiment, the device consists of horizontal and vertical members with a “Recessed Track” in which the steel overhead door tracks can be attached and thereby supported and concealed.

In another embodiment, the standard steel tracks are attached to the external surface of the device for added support and trim elements are added to both sides of the track provide concealment.

Further objects, features, advantages and properties of the device will become apparent from the detailed description and drawings provided.

### BRIEF DESCRIPTION OF THE DRAWINGS

FIG. 1 depicts a side view elevation of the device in one of the preferred embodiments, which is referred to in FIG. 1 and herein as the “Recessed Track”.

FIG. 2 illustrates a plan view of the embodiment of the device referenced in FIG. 1.

FIG. 3 illustrates, for the embodiment of the device referenced in FIG. 1, a cross section of the horizontal member.

FIG. 4 illustrates, for the embodiment of the device referenced in FIG. 1, a cross section of the vertical member.

FIG. 5 illustrates a side view elevation of the device in an alternative embodiment, which is referred to in FIG. 5 and herein as the “Externally Mounted Track”. In this embodiment, the overhead door tracks are not recessed within the horizontal and vertical members. Rather, the tracks are concealed from view by the manufacture or installation of trim elements, as shown.

FIG. 6 illustrates a plan view of the embodiment of the device referenced in FIG. 5.

FIG. 7 illustrates, for the embodiment of the device referenced in FIG. 5, a cross section of the horizontal member.

FIG. 8 illustrates, for the embodiment of the device referenced in FIG. 5, a cross section of the vertical member.

### DETAILED DESCRIPTION

Referring now in more detail to the drawing figures, wherein like reference numerals indicate like components throughout the several views. The following description is provided as an enabling teaching of embodiments of an article of manufacture for supporting and visually concealing tracks or rails commonly used in the operation of overhead door tracks. Those skilled in the relevant art will recognize that changes can be made to the embodiments described, while still obtaining useful results. It will also be apparent that some of the desired benefits of the embodiments described can be obtained by selecting some of the features of the embodiments without utilizing other features. Those who work in the art will recognize that many modifications and adaptations to the embodiments described are possible and may even be desirable in certain circumstances, and are part of the invention. Thus, the following description is provided as an illustration of the principles of the embodiments and not in limitation thereof, since the scope of the invention is to be defined by the claim.

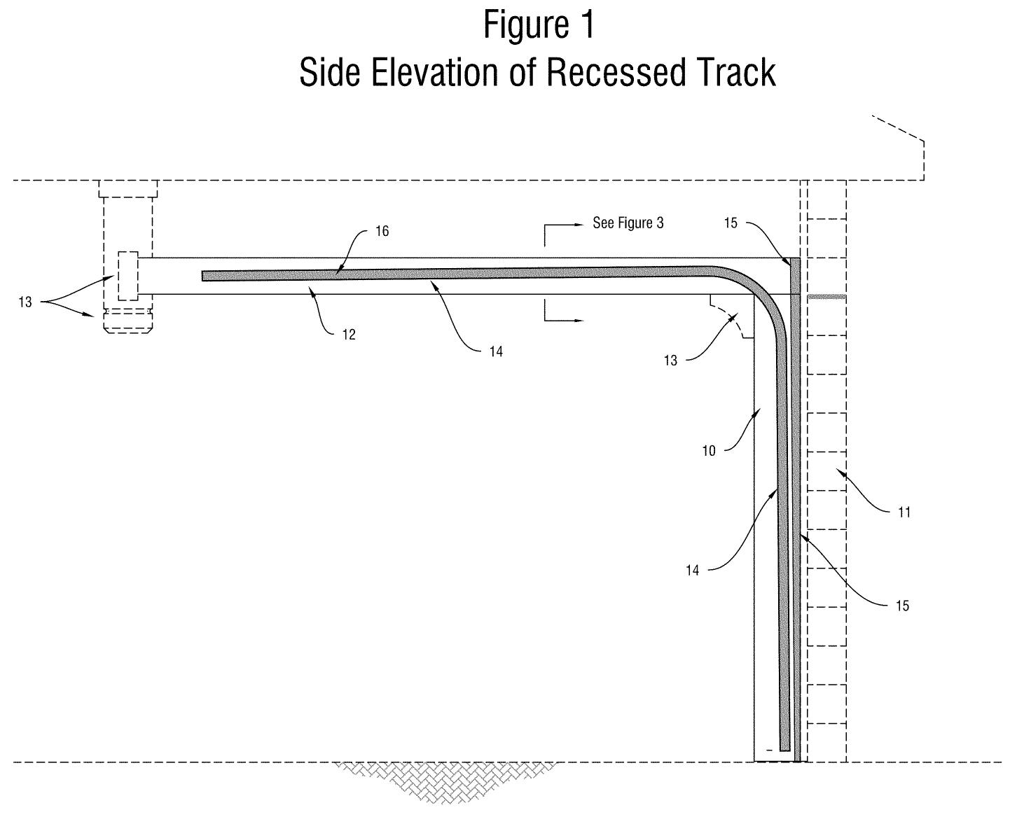

FIG. 1 depicts a side view elevation of the device in one of the preferred embodiments, which is referred to in FIG. 1 and herein as the “Recessed Track”. The device depicted consists of the following: a vertical member (10) to be installed adjacent to and against the wall of a structure (11) and along the outside edge of the doorway opening, and a horizontal member (12), supported on one end by the vertical member (10) described above, and which can be supported on the opposite end by any variety and means of support available through common construction materials and methods (13), including but not limited to posts, beams, rods, chains, hangers, pipes, or any combination thereof. Note that the support post and beams (represented by dashed lines) may be common to modern construction and are shown here for reference only. There may be a variety of many desirable methods for providing structural support for the device, other than the method depicted in these figures. The novelty in this device is found in the method and utility of support and concealment of the door tracks provided by the unique design and application of the vertical and horizontal members. Within the members described above, is a continuous recessed channel, referred to as the Track Channel (14), within which can be installed overhead door tracks (16). The tracks, which in common application are exposed, can be supported and concealed within the Track Channel (14). Also, within the vertical member (10), there is a separate recessed channel, referred to as the Cable Channel (15), which will allow for the free movement of cables commonly used to assist with the opening of overhead doors. Other commonly used overhead door hardware, such as torsion springs, drums, and automatic openers can be installed and used in conjunction with this new device. The vertical and horizontal members, which in part comprise the device, can be manufactured out of a variety of materials, depending upon the desired look and other details of the application, including, but not limited to, timber, aluminum, steel, fiberglass, polystyrene, PVC or other plastics, or other suitable natural, synthetic, or composite materials. The shape and dimensions of the vertical and horizontal members may vary as well depending upon structural needs and the look desired.

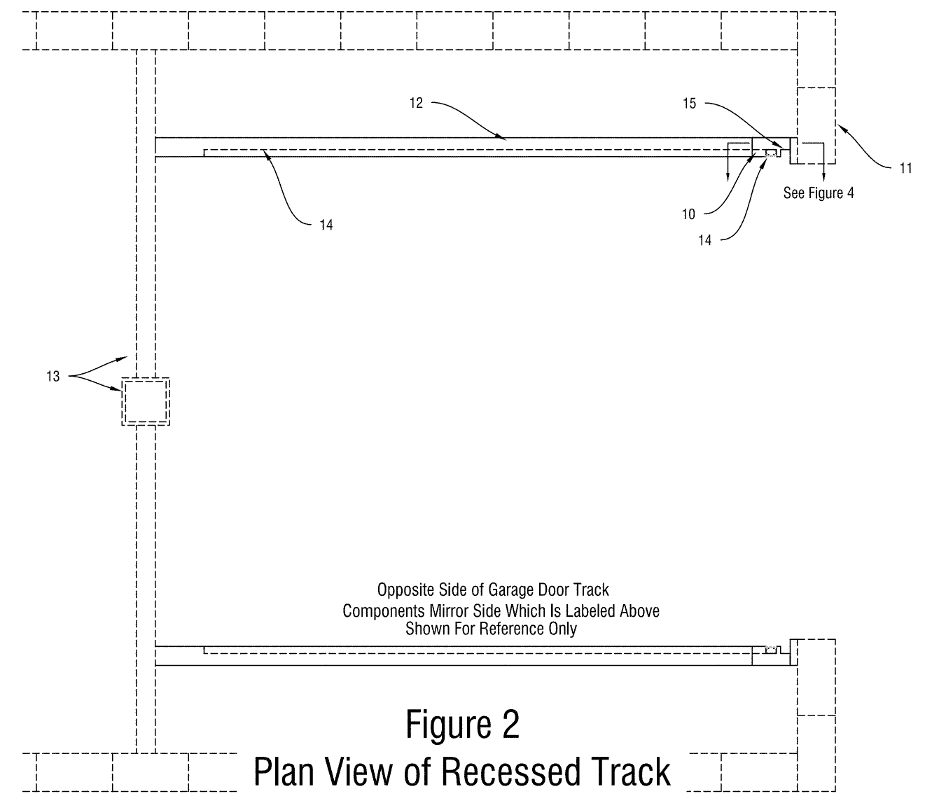

FIG. 2 illustrates a plan view of the embodiment of the device referenced in FIG. 1 and referred to as the “Recessed Track”. The view is as if one were above the device and looking down upon it. The vertical member (10) is shown abutting the exterior wall (11) of a structure, adjacent to a doorway opening. The recessed Track Channel (14) and Cable Channel (15) are depicted within the vertical member (10). The recessed Track Channel (14) is also represented by a dashed line within the horizontal member (12). For clarity, both sides of the overhead door track system are shown in FIG. 2, though only the top portion is labeled, as both sides are mirrors of one another. The horizontal and vertical members comprising the device can be supported by a variety of common construction materials and methods (13), as represented by the beams and posts depicted in FIG. 2 as dashed lines.

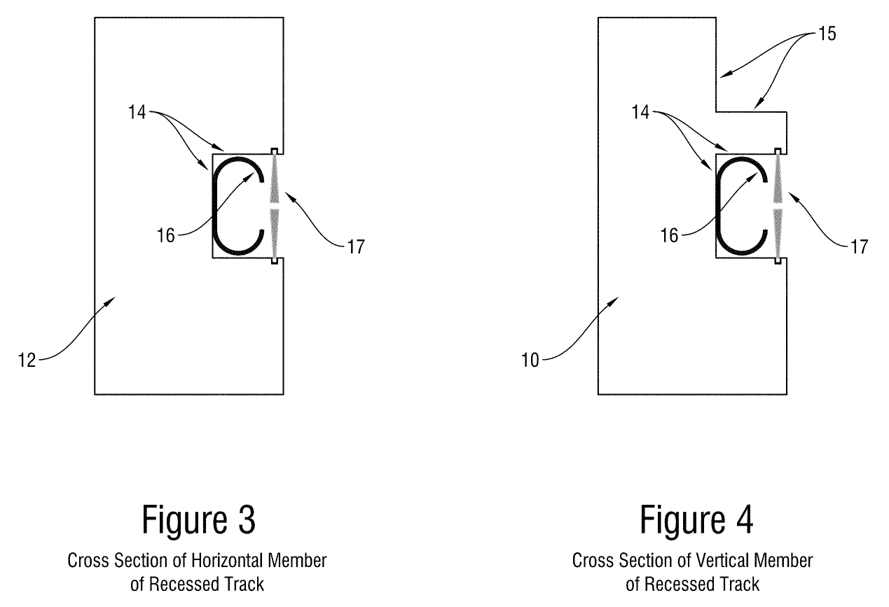

FIG. 3 is a cross section representative of the horizontal member (12) referenced in FIG. 1. Depicted in the cross section is the recessed Track Channel (14), within which is the inserted and attached door track (16). Depicted also in FIG. 2 is a line of weather stripping (17) along the outside boundary of the Track Channel (14) which serves the purpose of further concealing the track (16) from view. The weather stripping (17), as shown and as applied to this device, is considered novel and useful, but not entirely necessary in every application.

FIG. 4 is a cross section representative of the vertical member (10) referenced in FIG. 1. Depicted in the cross section is the recessed Track Channel (14), within which is the inserted and attached door track (16). Incorporated into the Track Channel (14) is a line of weather stripping (17) along the outside boundary which serves the purpose of further concealing the track (16) from view. The weather stripping (17), as shown and as applied to this device, is considered novel and useful, but not entirely necessary in every application. Also depicted in FIG. 4 is the recessed Cable Channel (15), which allows for space and vertical movement of the cables commonly used in the operation of overhead doors.

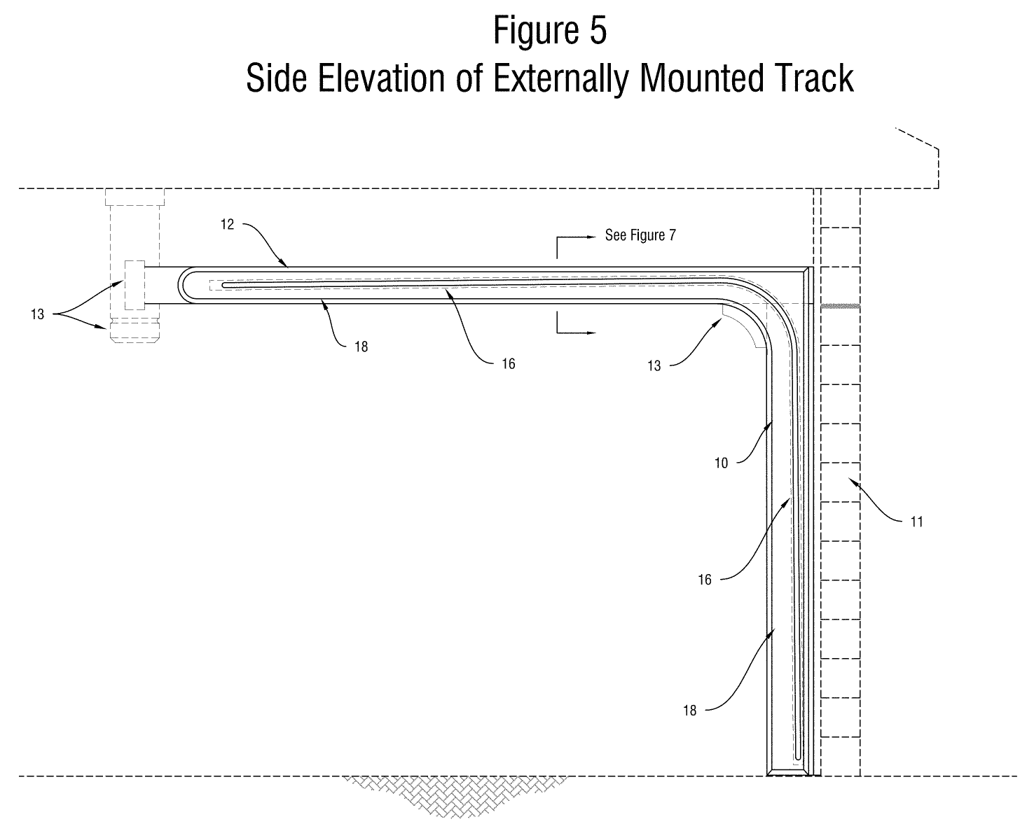

FIG. 5 depicts a side view elevation of the device in alternative embodiment, which is referred to in FIG. 5 and herein as the “Externally Mounted Track”. The device depicted consists of the following: a vertical member (10) to be installed adjacent to and against the wall (11) of a structure and along the outside edge of the doorway opening, and a horizontal member (12), supported on one end by the vertical member (10) described above, and which can be supported on the opposite end by any variety and means of support available through common construction materials and methods (13), including but not limited to posts, beams, rods, chains, hangers, pipes, or any combination thereof. Note that the support post and beams (represented by dashed lines) may be common to modern construction and are shown here for reference only. There may be a variety of many desirable methods for providing structural support for the device, other than the method depicted in these figures. The novelty in this device is found in the method and utility of support and concealment of the door tracks (16) provided by the unique design and application of the vertical and horizontal members. In this alternative embodiment, the overhead door tracks (16) are mounted to the exterior of the vertical and horizontal structural members. To conceal the tracks (16) from view, the vertical and horizontal members are manufactured with or appended with trim elements (18) parallel with the tracks (16) along the bottom of the horizontal member (12) and along the front of the vertical member (10). Commonly used overhead door hardware, such as torsion springs, drums, cables, and automatic openers can be installed and used in conjunction with this new device. The vertical and horizontal members, as well as the trim elements (18), which in part comprise the device, can be manufactured out of a variety of materials, depending upon the desired look and other details of the application, including timber, aluminum, steel, fiberglass, polystyrene, PVC or other plastics, or other suitable natural, synthetic, or composite materials. The shape and dimensions of the vertical and horizontal members may vary as well depending upon structural needs and the look desired.

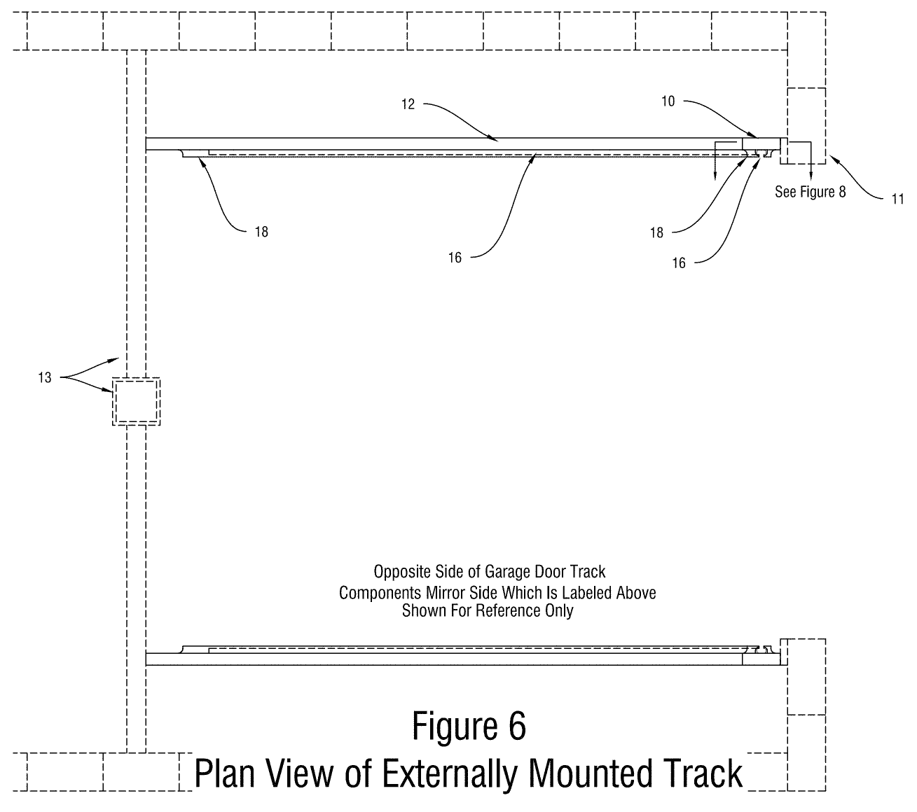

FIG. 6 illustrates a plan view of the embodiment of the device referenced in FIG. 5 and referred to as the “Externally Mounted Track”. The view is as if one were above the device and looking down upon it. The vertical member (10) is shown abutting the exterior wall (11) of a structure, adjacent to a doorway opening. The overhead door tracks (16) and trim elements (18) are depicted within the vertical member (10). The trim element (18) is also represented along the horizontal member (12). For clarity, both sides of the overhead door track system are shown in FIG. 2, though only the top portion is labeled, as both sides are mirrors of one another. The horizontal and vertical members comprising the device can be supported by a variety of common construction materials and methods (13), as represented by the beams and posts depicted in FIG. 2 as dashed lines.

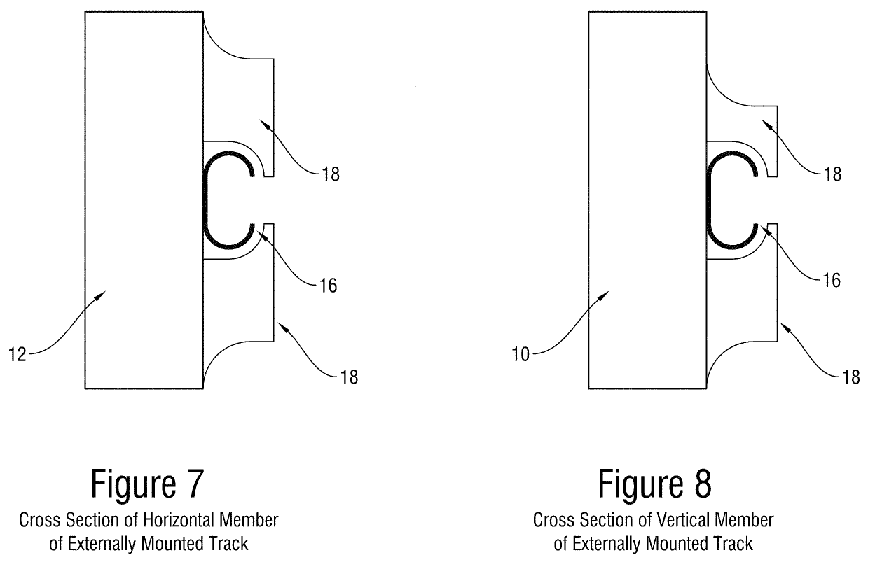

FIG. 7 is a cross section representative of the horizontal member (12) referenced in FIG. 5. Depicted in the cross section is the overhead door track (16), which is mounted directly on the side of the horizontal member (12). Below the track, extending from the horizontal member (12), is shown the trim elements (18) referred to in FIG. 5, which serve the purpose of shielding the tracks (16) from view.

FIG. 8 is a cross section representative of the vertical member (10) referenced in FIG. 5. Depicted in the cross section is the overhead door track (16), which is mounted directly on the side of the vertical member (10). In front of the track (16), extending from the vertical member (10), is shown the trim elements (18) referred to in FIG. 5, which serve the purpose of shielding the tracks (16) from view.

The invention has been described herein in terms of preferred embodiments and methodologies considered by the inventor to represent the best mode of application of the invention. It will be understood by one skilled in the relevant art, however, that a wide range of additions, deletions, and modifications, both subtle and gross, may be made to the illustrated embodiments without departing from the spirit and scope of the invention. These and other revisions might be made by those of skill in the art without departing from the spirit and scope of the invention.

The embodiments of the invention in which an exclusive property or privilege is claimed are defined as follows:

1. An article of manufacture which provides structural support for overhead door track systems while concealing the tracks from view, consisting of vertical and horizontal members, which attach to and support the tracks, and which are manufactured with recessed channels or trim elements for visual concealment of the tracks.

2. The combination defined in claim 1, wherein the vertical members contain a recessed channel not only for the support and concealment of the overhead door tracks, but also a separate recessed channel to allow for the free vertical movement and operation of cables commonly utilized in overhead door systems.

3. The combination defined in claim 1, wherein the recessed channels within the vertical and horizontal members are equipped with a type of weather stripping or similar material for the further visual concealment of the track systems.
